(19) United States
(12) Patent Application Publication
(10) Pub. No.: US 2014/0270155 A1
(43) Pub. Date: Sep. 18, 2014

(54) METHOD AND A DEVICE FOR FAULT-RESISTANT EXPONENTIATION IN CRYPTOGRAPHIC SYSTEMS

(71) Applicant: THOMSON LICENSING, Issy de Moulineaux (FR)

(72) Inventor: Marc JOYE, Fougeres (FR)

(73) Assignee: THOMSON LICENSING, Issy de Moulineaux (FR)

(21) Appl. No.: 14/198,958

(22) Filed: Mar. 6, 2014

(30) Foreign Application Priority Data
Mar. 11, 2013 (EP) 13305266.2

(51) Int. Cl. H04L 9/00

(52) U.S. Cl. CPC H04L 9/004; H04L 2209/34
USPC 380/28

(57) ABSTRACT

A processor in a device performs fault-resistant exponentiation using an input x and a secret exponent d to obtain a result S, by using an a priori selected integer r and a chosen random element a ε {0, . . . , r−1} to form an extended base \hat{x} is formed such that

$$\{ \begin{matrix}\hat{x} ≡ x ( mod N ) \\ \hat{x} ≡ 1 + a \cdot r ( mod {r}^{2} )\end{matrix}$$

In a generalization, for an a priori selected integer t=br² (where b is an integer) co-prime to a modulus N, the processor has a modular inverse i_{N}=N^{-N} mod t. The processor generates the extended base by computing \hat{x}=x+N·[i_{N}(1+ar−x) mod t] and then computes an extended modulus \hat{N}=Nt, computes Sᵣ=\hat{x}^{d} mod \hat{N}, verifies if Sᵣ≡1+dar(mod r²), and if and only if this is so, returns the result S=Sᵣ mod N via the interface.

### TECHNICAL FIELD

The present invention relates generally to cryptography, and in particular to a countermeasure against fault attacks in RSA-based or discrete-log based cryptography.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Throughout the application, the RSA cryptosystem will be used as an illustrative, non-limitative example, but it will be appreciated that the problem and its solution can for example be readily extended to cryptosystems based on discrete logarithms like for example the Diffie-Hellman key exchange and the ElGamal encryption scheme.

It is well known that the RSA cryptosystem, particularly when implemented using Chinese remaindering, is sensitive to fault attacks. This holds true for plain RSA but also for versions using a provable secure padding.

An efficient way to preclude fault attacks was proposed by Vigilant [see RSA with CRT: A new cost-effective solution to thwart fault attacks. In E. Oswald and P. Rohatgi, editors, Cryptographic Hardware and Embedded Systems—CHES 2008, volume 5154 of Lecture Notes in Computer Science, pages 130-145. Springer, 2008].

Vigilant's method works as follows. On input x and d, one has to compute S=x^{d} mod N (or x^{d} mod {p, q} in CRT mode), where the modulus N is a product of two chosen prime number p and q.

1. Choose a random integer r co-prime to N;

2. Compute β=N(N⁻¹ mod r²) and a=1−β mod Nr²;

3. Compute \hat{x}=ax+β(1+r) mod Nr² and \hat{N}=Nr²;

4. Compute Sᵣ=\hat{x}^{d} mod \hat{N};

5. If Sᵣ≡1+dr(mod r²) then return S=Sᵣ mod N; otherwise return an error message.

Vigilant's countermeasure works well to some extent, but it suffers from drawbacks: it involves the computation of a modular inverse (in step 2) and it extends the modulus (which is unavoidable) in a random manner. Since the modular inverse and the extension of the modulus depend on the random number, they are different from one exponentiation to the next.

It will thus be appreciated that it is desired to have a countermeasure that does not involve the computation of the modular inverse as Vigilant does. The present invention provides a countermeasure that overcomes at least some of the disadvantages of Vigilant's countermeasure.

### SUMMARY OF INVENTION

In a first aspect, the invention is directed to a method of performing fault-resistant exponentiation using an input x, a secret exponent d and a modulus N to obtain a result S. A processor having a predetermined value r: receives the input x; computes an intermediate result Sᵣ using modular exponentiation involving the secret exponent d, an extended base 2 and an extended modulus \hat{N}, wherein the extended base \hat{x} is computed using the input x and a random value a, and wherein the extended modulus \hat{N} is computed using the modulus N and the predetermined value r and is independent of the random value a; verifies that Sᵣ satisfies an equation involving the random value a calculated modulus a multiple of the predetermined value r, and returns the result S=Sᵣ mod N if and only if the verifying is successful.

In a first embodiment, the processor further chooses the random element a.

In a second embodiment, the random value a ε [symbol] /r [symbol] .

In a third embodiment, the processor further computes the extended base \hat{x}=x+N·[i_{N}(1+ar−x)mod t], wherein i_{N}=N⁻¹ mod t is a modular inverse, t is co-prime to the modulus N and t=br², where r and b are integers. It is advantageous that the processor further computes the extended modulus \hat{N}=Nt.

In a fourth embodiment, the intermediate value Sᵣ is calculated as Sᵣ=\hat{x}^{d} mod \hat{N}.

In a fifth embodiment, the equation that the intermediate value Sᵣ is to satisfy is Sᵣ≡1+dar(mod r²).

In a second aspect, the invention is directed to a device for performing exponentiation using an input x, a secret exponent d and a modulus N to obtain a result S, the exponentiation being resistant to fault attacks. The device comprises: an interface configured to received the input x and to output the result S; and a processor configured to: compute an intermediate result Sᵣ using modular exponentiation involving the secret exponent d, an extended base \hat{x} and an extended modulus \hat{N}, wherein the extended base \hat{x} is computed using the input x and a random value a, and wherein the extended modulus \hat{N} is computed using the modulus N and a predetermined value r and is independent of the random value a, wherein the processor is configured to use the predetermined value r for a plurality of exponentiations; verify that Sᵣ satisfies an equation involving the random value a calculated modulus a multiple of the predetermined value r, and send the result S=Sᵣ mod N to the interface (110) if and only if the verifying is successful.

In a first embodiment, the processor is further configured to choose the random element a.

In a second embodiment, the random value a ε [symbol] /r [symbol] .

In a third embodiment, the processor is further configured to compute the extended base \hat{x}=x+N·[i_{N}(1+ar−x)mod t], wherein i_{N}=N⁻¹ mod t is a modular inverse, t is co-prime to the modulus N and t=br², where r and b are integers.

In a fourth embodiment, the device is one of: a computer, a mobile telephone, a Smartphone, a tablet and a gateway.

In a fifth embodiment, the processor is configured to calculate the intermediate value Sᵣ as Sᵣ=\hat{x}^{d} mod \hat{N}.

In a sixth embodiment, the equation that the intermediate value Sᵣ is to satisfy is Sᵣ≡1+dar(mod r²).

In a third aspect, the invention is directed to a non-transitory computer medium storing instructions that, when executed by a processor, perform the method of the first aspect.

### BRIEF DESCRIPTION OF DRAWINGS

Preferred features of the present invention will now be described, by way of non-limiting example, with reference to the accompanying drawings, in which:

FIG. 1 illustrates a cryptographic device with a countermeasure against fault attacks according to a preferred embodiment of the invention; and

FIG. 2 illustrates a method for fault-resistant exponentiation according to a preferred embodiment of the invention.

### DESCRIPTION OF EMBODIMENTS

It will be appreciated that, given a random integer r, Vigilant's countermeasure transforms input base x into extended base \hat{x} such that

$$\{ \begin{matrix}\hat{x} ≡ x ( mod N ) \\ \hat{x} ≡ 1 + r ( mod {r}^{2} )\end{matrix}$$

As already mentioned, apart from the computation of the modular inverse in step 2, a further drawback is that the extended modulus Nr² is constructed at random, which can contradict its efficient use. Indeed, some exponentiation algorithms impose conditions on the modulus. As a consequence, the extended modulus must then usually be further enlarged to comply with these conditions.

A main idea of the present invention is thus to construct a “random” element modulo r² for a fixed element r (and thus a fixed extended modulus \hat{N}). In other words, the extended modulus is now predetermined for a chosen, fixed r. This way, both the computation of the modular inverse can be avoided (it can be calculated once and for all) and the extended modulus can be selected so as to comply with the conditions imposed on the modulus. For security, randomness is needed. In Vigilant's method, randomness is introduced by the choice of r. Note that in the present invention, since r is fixed, randomness is needed elsewhere; this is why the extended base modulo r² (i.e., \hat{x} mod r²) is chosen as a random element, as opposed to Vigilant's method. Indeed, if r were fixed in Vigilant's method then so would be \hat{x} mod r², namely \hat{x}≡130 r(mod r²).

FIG. 1 illustrates a cryptographic device 100 with a countermeasure against fault attacks according to a preferred embodiment of the invention. The device 100 comprises at least one interface unit 110 configured for communication, at least one processor (“processor”) 120 and at least one memory 130 configured for storing data, such as accumulators and intermediary calculation results. The device 100 can for example be a computer, a mobile telephone, a Smartphone, a tablet or a gateway. The Figure also shows a first computer program product (non-transitory storage medium) 140 such as a CD-ROM or a DVD comprises stored instructions that, when executed by the processor 120, performs exponentiation according to the invention.

As for the exponentiation algorithm (which, it is again pointed out, is compatible with RSA as a non-limitative example), it is first to be noted and easily verified that (1+r) generates the subgroup G₁={x ε [symbol] /r² [symbol] |x≡1(mod r)}. The elements of G₁ are 1+a·r with a ε {0, . . . , r−1}.

As already mentioned, the preferred embodiment uses an a priori selected integer r. In order to provide the countermeasure, a random element a ε {0, . . . , r−1} is chosen and the extended base \hat{x} is formed such that

$$\{ \begin{matrix}\hat{x} ≡ x ( mod N ) \\ \hat{x} ≡ 1 + a \cdot r ( mod {r}^{2} )\end{matrix}$$

This can easily be generalized to an a priori selected integer t=br² (where b is an integer>0 that can be squarefree or not).

For the a priori selected integer t=br² co-prime to N, the processor 110 obtains or computes a modular inverse i_{N} =N⁻¹ mod t.

The device 100 is then ready to perform modular exponentiation resistant to fault attacks, using an input x received via the interface 110 and a (secret) exponent d, as follows and as illustrated in FIG. 2:

S1. Choose a random element a ε [symbol] /r [symbol] ;

S2. Compute \hat{x}=x+N·[i_{N}(1+ar −x)mod t];

S3. Compute \hat{N}=Nt;

S4. Compute Sᵣ=\hat{x}^{d}mod\hat{N};

S5. Verify if Sᵣ≡1+dar(mod r²).

S6. If and only if so, return S=Sᵣ mod N via the interface 110; otherwise return an error message.

It is worth noting that since t is fixed, the value of i_{N} can be precomputed. No modular inverse is therefore required for the evaluation of \hat{x}.

As will be shown, the method of the present invention nicely combines with existing implementations. For example, Quisquater's algorithm [see U.S. Pat. No. 5,166,978, Encoding system according to the so-called RSA method, by means of a microcontroller and arrangement implementing this system]—used in all Philips's (now NXP) co-processors—requires a modulus with its c most significant bits equal to 1. This can be achieved by multiplying modulus N by some appropriately chosen factor δ [see M. Joye. On Quisquater's multiplication algorithm. In D. Naccache, editor, Cryptography and Security: From Theory to Applications, volume 6805 of Lecture Notes in Computer Science, pages 3-7. Springer, 2012].

Applied to the proposed method, it is for example possible to set t=δ. In this particular case, it is worth noting that the countermeasure comes virtually for free (as no extra working memory is required and the overall cost is very low).

It will thus be appreciated that the present invention can provide a countermeasure that does not require inversion (apart from the one that can be pre-computed), which is the main bottleneck in Vigilant's countermeasure and which means that the present method can achieve better performance speed-wise and reduced requirements for working memory if the same processors and sensible implementations are used. Further, the proposed countermeasure nicely combines with certain modular multiplication algorithms that already extend the modulus.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. A method of performing modular exponentiation using an input x, a secret exponent d and a modulus N to obtain a result S, the exponentiation being resistant to fault attacks, the method including at least the following steps in a processor of a device, the processor having a predetermined value r, of:
receiving the input x;
computing an intermediate result Sᵣ using modular exponentiation involving the secret exponent d, an extended base \hat{x} and an extended modulus \hat{N}, wherein the extended base \hat{x} is computed using the input x and a random value a, and wherein the extended modulus \hat{N} is computed using the modulus N and the predetermined value r and is independent of the random value a;
verifying that Sᵣ satisfies an equation involving the random value a calculated modulus a multiple of the predetermined value r, and
return the result S=Sᵣ mod N if and only if the verifying is successful.

2. The method of claim 1, further comprising the step of choosing (S1) the random element a.

3. The method of claim 1, wherein the random value a ε [symbol] /r [symbol] .

4. The method of claim 1, further comprising the step of computing the extended base \hat{x}=x+N·[i_{N}(1+ar−x) mod t], wherein i_{N}=N⁻¹ mod t is a modular inverse, t is co-prime to the modulus N and t=br², where r and b are integers.

5. The method of claim 4, further comprising the step of computing the extended modulus \hat{N}=Nt.

6. The method of claim 1, wherein the intermediate value Sᵣ is calculated as Sᵣ=\hat{x}^{d} mod \hat{N}.

7. The method of claim 1, wherein the equation that the intermediate value Sᵣ is to satisfy is Sᵣ≡1+dar(mod r²).

8. A device for performing exponentiation using an input x, a secret exponent d and a modulus N to obtain a result S, the exponentiation being resistant to fault attacks, the device comprising:
an interface configured to received the input x and to output the result S; and
a processor configured to:
compute an intermediate result Sᵣ using modular exponentiation involving the secret exponent d, an extended base \hat{x} and an extended modulus \hat{N}, wherein the extended base \hat{x} is computed using the input x and a random value a, and wherein the extended modulus \hat{N} is computed using the modulus N and a predetermined value r and is independent of the random value a, wherein the processor is configured to use the predetermined value r for a plurality of exponentiations;
verify that Sᵣ satisfies an equation involving the random value a calculated modulus a multiple of the predetermined value r, and
send the result S=Sᵣ mod N to the interface if and only if the verifying is successful.

9. The device of claim 8, wherein the processor is further configured to choose the random element a.

10. The device of claim 8, wherein the random value a ε [symbol] /r [symbol] .

11. The device of claim 8, wherein the processor is further configured to compute the extended base \hat{x}=x+N·[i_{N}(1+ar−x) mod t], wherein i_{N}=N⁻¹ mod t is a modular inverse, t is co-prime to the modulus N and t=br², where r and b are integers.

12. The device of claim 11, wherein the device is one of a group of: a computer, a mobile telephone, a Smartphone, a tablet and a gateway.

13. The device of claim 8, wherein the processor is configured to calculate the intermediate value Sᵣ as Sᵣ=\hat{x}^{d} mod \hat{N}.

14. The device of claim 8, wherein the equation that the intermediate value Sᵣ is to satisfy is Sᵣ≡1+dar(mod r²).

15. A non-transitory computer medium storing instructions that, when executed by a processor, perform the method of claim 1.
